(19) United States
(12) Patent Application Publication
(10) Pub. No.: US 2006/0043656 A1
(43) Pub. Date: Mar. 2, 2006

(54) Engine mount

(75) Inventor: Yorishige Shimizu, Iwakura-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/207,840

(22) Filed: Aug. 22, 2005

(30) Foreign Application Priority Data
Aug. 31, 2004 (JP) 2004-253081
Nov. 29, 2004 (JP) 2004-344570
Feb. 28, 2005 (JP) 2005-054298

(51) Int. Cl. F16F 13/00

(52) U.S. Cl. 267/140.11; 267/140.13

(57) ABSTRACT

An engine mount wherein an elastic body connecting upper and lower rigid members has a front-back dimension of its upper half smaller than that of its lower half with the upper half constitutes a front-back direction rubber stopper portion opposed to and spaced apart from a pair of leg portions of a bridge shaped stopper member in the front-back direction by a stopper clearance. The bridge shaped stopper member is press fitted onto the elastic body and the lower rigid member by being assembled through an opening of a lower end thereof, with the lower half clamped elastically between the pair of leg portions. With the stopper member being press fitted onto the elastic body and the lower rigid member, the pressing portions of the stopper member press downwardly the shoulder portions of the elastic body causing compression deformation of the lower half, producing a state of fixation of the lower half to the stopper member.

### INCORPORATED BY REFERENCE

The disclosure of Japanese Patent Application No. 2004-253081 filed on Aug. 31, 2004, No. 2004-344570 filed on Nov. 29, 2004, and No. 2005-054298 filed on Feb. 28, 2005, each including the specification, drawings and abstract is incorporated herein by reference in its entirety.

### BACKGROUND OF THE INVENTION

1. Field of the Invention

This invention relates to an engine mount for supporting an engine on a vehicle body in a vibration damping fashion, and in particular to an engine mount of a configuration which comprises a stopper member that is a rigid member of bridge shaped, and which provides vibration-damping support of the engine in a suspension manner.

2. Description of the Related Art

Various types of engine mounts that providing vibration-damping support of an engine have been employed. One type is of a configuration which comprises a bridge shaped stopper metal member (rigid stopper member), and which provides vibration-damping support of the engine in a suspension manner.

JP-A-5-18428, JP-A-8-233010 and JP-A-8-296681 disclose engine mounts furnished with bridge-type metal members. However, the designs disclosed in these documents differ in object from the present invention in that they lack an arrangement wherein the upper half of the rubber elastic body constitutes a stopper portion in the front-back direction, and in that the bridge-type metal member is not constituted as a stopper metal member that restricts front-back displacement through cooperative action with the rubber stopper portion.

### SUMMARY OF THE INVENTION

Present inventors has originally made several prototypes of an engine suspension type engine mount. FIGS. 7A and 7B show, by way of a comparative example II, an engine suspension type engine mount with a bridge shaped stopper metal member of this kind, produced as a prototype by the inventors. In the drawing, symbol 200 denotes an upper metal member (upper rigid member) affixed to the engine side, 204 denotes a lower metal member (lower rigid member) affixed to the vehicle body side, and 206 denotes a rubber elastic body integrally fixed to these by means of vulcanization bonding, linking the two together.

As shown in FIG. 8, the upper metal member 200 has integrally constituted therewith a bracket metal member (rigid bracket) 201 that extends in the same axial direction from a first axial end thereof, for linking the upper metal member 200 to the engine side. The engine is secured fastened to the end of this bracket 201 so as to be supported in a suspended configuration.

The rubber elastic body 206 has a front-back dimension of its upper half 210 that is smaller than the front-back (corresponding to the right-left direction in the drawing) dimension of its lower half 208, with rubber stopper portions 212 being formed in the front-back direction by this upper half 210. 214 denotes a bridge shaped stopper metal member having a pair of leg portions 216 situated at front and back, and a bridge portion 218 that connects the pair of leg portions 216 at the top of the rubber elastic body 206.

With this engine mount 202, the bridge shaped stopper metal member 214 is pushed downwardly in the drawing, press metal member the rubber elastic body 206 into it through the opening at the bottom of the stopper metal member 214, and attached thereby to the rubber elastic body 206 and the lower metal member 204 with the lower half 208 of the rubber elastic body 206 clamped elastically between the pair of leg portions 216. More specifically, the inner faces 220 of the press fit pair of leg members are disposed in elastic pressing contact with front and back contact faces 222 of the lower half 208 in the rubber elastic body 206, and in this state a fastener portion 224 at the bottom end of each leg portion 216 is fastened to a fastener portion 226 on the lower metal member 204, whereby the bridge shaped stopper metal member 214 is attached to the rubber elastic body 206 and the lower metal member 204.

This assembled state is depicted in FIG. 7B. The rubber stopper portions 212 in the front-back direction of the upper half 210 in the rubber elastic body 206 is situated in opposition to the pair of leg portions 216 of the stopper metal member 214 and spaced apart therefrom in the front-back direction by stopper clearance. These rubber stopper portions 212 come into abutment with the leg portions 216 to produce stopper action when the engine experiences appreciable relative displacement in the front-back direction, restricting excessive front-back displacement of the engine.

This engine mount 202 is mounted elastically supporting the left-right edge (specifically, the edge on the left side) of the engine, and together with other engine mounts elastically supports the engine, and provides vibrational isolation between the engine side and the vehicle body side by means of elastic deformation of the rubber elastic body 206.

In this engine mount 202, the inner faces 220 of the leg portions 216 of the bridge shaped stopper metal member 214 and the front/back contact faces 222 of the lower half 208 of the rubber elastic body 206 are simply in elastic pressure-contact, without being adhered to each other. On the other hand, there is an inherent characteristic problem in that since the engine is supported in a suspension system, and since moreover the bracket metal member 201 extends integrally in the axial direction from the upper metal member 200 of the engine mount 202 so as to be supported in cantilever fashion by the rubber elastic body 206, when the engine gives rise to relative motion in pitching mode, i.e. when the left/right edges of the engine undergo vertical motion in opposite phase so that the engine overall gives rise to rocking motion, the bracket 201 integrally constituted with the upper metal member 200 as shown in FIG. 8 will undergo appreciable rotary motion in the vertical direction in the drawing. Therefore, the front/back contact faces 222 of the lower half 208 of the rubber elastic body 206 will undergo rubbing motion against the inner faces 220 of the leg portions 216 of the bridge shaped stopper metal member 214, whereby the rubber elastic body 206 will become abraded by the contact faces 222, and noise will tend to be produced by rubbing at this time.

It is therefore an object of the present invention to provide an engine mount wherein an upper half of a rubber elastic body constitutes a rubber stopper portion in a front-back direction, and which is capable of suppressing abrasion due to rubbing, and preventing noise produced by such rubbing, occurring at contact faces between an lower half of the rubber elastic body and a bridge shaped rigid stopper member.

Mode 1 of the invention provides an engine mount for a vehicle comprising: an upper rigid member fixable to an engine side; a lower rigid member fixable to an vehicle body side; a rubber elastic body elastically connecting the upper and lower rigid members; and a rigid stopper member of overall bridge configuration having a pair of leg portions situated at front and back and a bridge portion linking these leg portions in a front-back direction of the vehicle above the rubber elastic body, wherein the rubber elastic body has a front-back dimension of an upper half thereof smaller than that of a lower half thereof; the upper half constitutes a front-back direction rubber stopper portion opposed to and spaced apart from the pair of leg portions of the bridge shaped stopper member in the front-back direction by a stopper clearance; the bridge shaped stopper member is press fitted onto and attached to the rubber elastic body and the lower rigid member by being assembled through an opening of a lower end thereof, with the lower half clamped elastically between the pair of leg portions; a rigid bracket for linking the upper rigid member to the engine side is integrally formed on the upper rigid member, with the rubber elastic body supporting the bracket in a cantilever fashion so that the engine secured fastened to the bracket being supported in a suspension fashion; the upper rigid member and the lower rigid member are integrally vulcanization bonded to the rubber elastic body; a pair of shoulder portions of step configuration projecting in the front-back direction from an upper end of the lower half are disposed at front and back on the rubber elastic body, while downturned pressing portions of step configuration are disposed at corresponding front and back locations on the bridge shaped stopper member; and with the stopper member being press fitted onto the rubber elastic body and the lower rigid member, the pressing portions of the stopper member press downwardly the shoulder portions of the rubber elastic body causing compression deformation of the lower half, producing a state of fixation of the lower half to the stopper member.

Mode 2 of the invention provides an engine mount according to the aforementioned Mode 1, wherein each of the shoulder portion has a shape prior to attachment of the stopper member, in which a portion that contacts the pressing portion includes an upwardly projecting convex portion at an outer portion thereof in the front-back direction, and a relatively downward facing concave portion at an inner portion thereof.

Mode 3 of the invention provides an engine mount according to the aforementioned Mode 2, wherein the pressing portion has a shape that presses the upwardly projecting convex portion until the convex portion is rendered non-convex by means of attachment.

Mode 4 of the invention provides an engine mount according to any of the aforementioned Modes 1-3, wherein each of the shoulder portions is formed over an entirety of a width direction of the rubber elastic body which is a left-right direction of the vehicle, and each of the pressing portions is formed as a pair of pressing portions located at opposite ends in the width direction of the stopper member, with a portion lying between the pair of pressing portions at the opposite ends in the width direction being constituted as a reinforcing rib.

Mode 5 of the invention provides an engine mount according to any one of the aforementioned Modes 1-4, wherein in the rubber elastic body, portions extending from front and back stopper faces down to front and back contact faces of the lower half against the stopper member are continuous with contact faces without creating a constricted portion in the front-back direction at midpoint.

Mode 6 of the invention provides an engine mount according to any one of the aforementioned Modes 1-5, wherein portions of the lower rigid member that are opposed vertically to the pressing portions are formed as upturned convex portions.

Mode 7 of the invention provides an engine mount according to the aforementioned Mode 6, wherein each of the upturned convex portions of the lower rigid member includes in an outside of a vertex thereof in the front-back direction, a pressure surface extending towards an inside surface of the leg portion opposed thereto as it goes downward, and the corresponding shoulder portion of the rubber elastic body 16 is configured so as to extend toward the inside surface of the corresponding leg portion beyond the vertex.

Mode 8 of the invention provides an engine mount according to the aforementioned Mode 7, wherein the shoulder portions of the rubber elastic body have the upturned convex portions at their most outer peripheral edge portions in the front-back direction.

Mode 9 is an engine mount according to any one of the aforementioned Modes 6-8 wherein the convex portions of the lower rigid member are embedded within the interior of the lower half of the rubber elastic body, and exert restraining action from an interior of the rubber elastic body against portions of the lower half clamped by the stopper member.

Mode 10 is an engine mount according to the aforementioned Mode 9, wherein the convex portions of the lower rigid member have straight shaped portions that rise straight along the leg portions in the bridge shaped stopper member, with thin rubber layers constituting part of the rubber elastic body being formed between the straight shaped portions and the leg portions, respectively.

Mode 11 is an engine mount according to any one of the aforementioned Modes 1-10, wherein an entire fastener portion to the rubber elastic body of the lower rigid member is embedded within the rubber elastic body, with a rubber underlayer constituting part of the rubber elastic body being formed below the lower rigid member.

### OPERATIONS AND EFFECTS OF THE INVENTION

In the present invention as described hereinabove, the pair of shoulder portions of step configuration projecting in the front-back direction are disposed at the upper end of the lower half of the rubber elastic body, while a downturned pair of pressing portions of step configuration are disposed at corresponding front and back locations on the bridge shaped stopper member. When attaching the stopper member by means of press fitting, the shoulder portions of the rubber elastic body are pushed downwardly by the pressing portions, producing a state of fixation of the lower half to the rubber elastic body to the stopper member.

According to the present invention, even in the case where the engine mount is an engine mount that supports the engine in a suspension fashion, that is, one in which, due to left/right rocking motion of the engine in pitching mode, and additionally due to the bracket being integrally constituted in the cantilever fashion on the upper rigid member, the bracket undergoes appreciable rotary motion in the vertical direction, and a high level of force acts so as to produce relative motion (motion in the vehicle left-right direction) of the lower half of the rubber elastic body and the bridge shaped stopper member, and additionally the rubber elastic body has not been adhered to the bridge shaped stopper member, it is nevertheless possible, by means of the fastening action of the pressing portions, to suppress the occurrence of the contact faces of the lower half of the rubber elastic body rubbing against the stopper member during motion of the engine, in particular, principally the aforementioned left-right rocking motion in pitching mode, and to thereby better prevent abrasion of the rubber elastic body due to such rubbing, as well as to effectively prevent noise produced by such rubbing. Additionally, with the present invention, the lower rigid member together with the upper rigid member is integrally vulcanization bonded to the rubber elastic body, affording strong anchoring force of the lower rigid member to the lower half of the rubber elastic body, and thereby better preventing abrasion of the contact faces of the rubber elastic body and noise produced by such rubbing.

On the other hand, with this engine mount, the upper half in the rubber elastic body, more specifically the front-back direction rubber stopper portions formed in the upper half thereof, is opposed to the bridge shaped stopper member in a non-contacting state spaced apart therefrom by stopper clearance. Therefore, when the engine undergoes appreciable relative displacement in the front-back direction, maximum displacement can be better restricted by means of the stopper action of the rubber stopper portions. Additionally, with the present invention, by means of varying the compressive deformation allowance of the rubber elastic body, i.e. the pre-compression level, by the pressing portion of the stopper member, it is possible to variously modify and adjust the spring constant of the rubber elastic body, which has the advantage of greater freedom in tuning the spring constant of the engine mount.

Next, Mode 2 is the engine mount wherein the shape of the shoulder portion, more specifically the shape of the shoulder portion prior to attachment of the stopper member, is one in which, of the portion that contacts the pressing portion, the outer portion thereof in the front-back direction constitutes an upwardly projecting convex portion, and the inner portion thereof constitutes a relatively downward facing concave portion.

Where the shape of the shoulder portion is one that, for example, contacts the pressing portions of the stopper member with equal force at all points, relative displacement of the engine during use will be accompanied by concentrations of stress in border regions between portions contacted by the pressing portions and portions not contacted, and cracks can occur from these sites, thus creating the problem of diminished durability of the engine mount. Nevertheless, with Mode 2, since the outer portion in the front-back direction constitutes the upward facing convex portion, and the inner portion constitutes the downward facing concave portion, even where the shoulder portions of the rubber elastic body are in the downwardly pressed state due to attachment of the stopper member, concentrations of stress in the aforementioned border regions can be better avoided. Accordingly the problem of cracks occurring from these border regions and diminishing the durability of the engine mount can be better resolved, so that the durability of the rubber elastic body, i.e. of the engine mount, can be made better.

The aforementioned pressing portion can be given a shape that presses the convex portion and induces elastic compressive deformation, until the convex portion prior to assembly is rendered non-convex by means of attachment (Mode 3).

Next, according to Mode 4, the aforementioned shoulder portions can be formed over the entirety of the width direction (vehicle left-right direction) of the rubber elastic body on the one hand, while the pressing portions are disposed partially at each end in the width direction of the stopper member, with portions in the width direction between the pressing portions being constituted as reinforcing ribs. By so doing, reduced strength in the front-back direction of the stopper member due to formation of the pressing portions is prevented by the reinforcing ribs, and rigidity and strength of the stopper member in the front-back direction can be maintained at high levels of rigidity and strength.

In the present invention, portions of the rubber elastic body extending from the front and back stopper faces down to the contact faces of the lower half against the stopper member can be constituted as surfaces that are continuous with the contact faces, without creating a constricted portion in the front-back direction at midpoint (Mode 5).

Next, Mode 6 is an engine mount wherein portions of the aforementioned lower rigid member that are opposed vertically to the pressing portions in the stopper member are upturned convex portions. Thus, according to this Mode 6, the front end and the back end of the lower half in the rubber elastic body can be fastened more securely by means of the pressing portions of the stopper and the convex portions of the lower rigid member, and rubbing of the stopper member of the rubber elastic body against the contact faces can be effectively suppressed. The upturned convex portions of this lower rigid member also have the action of producing a stiffer spring constant of the rubber elastic body, and thus there is the additional advantage that by varying the projection height of the convex portions, the tuning range of the spring constant of the rubber elastic body is expanded.

Next, Mode 7 is an engine mount wherein each of the upturned convex portions of the lower rigid member includes in an outside of a vertex thereof in the front-back direction, a pressure surface extending towards an inside surface of the leg portion opposed thereto as it goes downward, and the corresponding shoulder portion of the rubber elastic body 16 is configured so as to extend toward the inside surface of the corresponding leg portion beyond the vertex. With this arrangement, when assembling the bridge shaped stopper member in order to press downward the rubber elastic body (more specifically, the lower half), the part of the rubber elastic body undergoing compression elastic deformation is pressed toward the inside surface sides of the leg portions due to the pressure surfaces of the upturned convex portions. This arrangement makes it possible to increase a frictional force generated between the contact surfaces of the rubber elastic body and the inside surfaces of the leg portions, resulting in increased bonding and fastening forces.

The part of the rubber elastic body pressed out by means of the function of the rubber are pre-compressed between the inside surfaces of the leg portions and the upturned convex portions, so that the deformation caused by means of the rocking motion of the bracket can be effectively absorbed. This as well as the increased bonding and fastening forces further effectively prevent rubbing of the contact surfaces of the lower half in the rubber elastic body and the inside surfaces of the leg portions, whereby rubbing of the lower half in the rubber elastic body and noise resulting from this can be more effectively prevented.

In the case of Mode 8, the shoulder portions of the rubber elastic body have the upturned convex portions at their most outer peripheral edge portions in the front-back direction. Therefore, when the pressure portions press the shoulder portions downwards, the downward compression elastic deformation of the convex portions at the outer peripheral edge portions of the shoulder portions promptly converted into compression force in the front-back direction against the inside surfaces of the leg portions of the stopper member. Therefore, the frictional force generated between the contact surfaces of the rubber elastic body and the inside surfaces of the leg portions can be increased, and accordingly the resultant bonding force as well as the pre-compression can be created effectively. Thus, rubbing of the lower half in the rubber elastic body and noise resulting from this can be more effectively prevented, furthermore.

In this case of Mode 9, the convex portions of the lower rigid member are embedded within the interior of the lower half of the rubber elastic body, and exert restraining action from an interior of the rubber elastic body against portions of the lower half clamped by the stopper member. By so doing, rubbing of the lower half in the rubber elastic body and noise resulting from this can be more effectively prevented.

In this case, the convex portion of the lower rigid member may have the straight shaped portion that rises straight along the leg portion in the bridge shaped stopper member, with a thin rubber layer constituting part of the rubber elastic body being formed between the straight shaped portion and the leg portion (Mode 10). In this case, the lower half of the rubber elastic body in the portion where the straight shaped portion is formed is held between the straight shaped portion and the leg portion, at uniform thickness over a predetermined distance in the vertical direction, whereby the desired interference can be readily assured when press metal member the rubber elastic body into the bridge shaped stopper member.

Next, Mode 11 is an engine mount, wherein the entire fastener portion of the lower rigid member to the rubber elastic body is embedded in the interior thereof, with a rubber underlayer constituting part of the rubber elastic body being formed below the lower rigid member. According to Mode 11, when the lower rigid member is constituted by a metal member which is integrally vulcanization bonded to the rubber elastic body during vulcanization molding, it is not necessary to give the forming mold a cut structure for the lower rigid member, whereby the design of the forming mold and the structure of the engine mount may be simplified, as well as solving the problem of rubber flash at the end of the lower rigid member; further, the labor entailed in a separate anticorrosive coating process on the bottom face of the lower rigid member (lower face of the portion embedded in the rubber elastic body) may be avoided.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is a perspective elevational view of an engine mount of construction according to a first embodiment of the invention;

FIG. 2 is a vertical or axial cross sectional view of the engine mount of FIG. 1;

FIG. 3 is an exploded perspective view of a stopper member and a rubber elastic body of the engine mount of FIG. 1;

FIG. 4 is a schematic view showing a state where the engine mount of FIG. 1 is installed on a vehicle;

FIGS. 5A and 5B are illustrations for explaining steps of assembly of the engine mount of FIG. 1;

FIGS. 6A and 6B are views of a comparative example I for explaining advantages of the present invention;

FIG. 7A and 7B are views of a comparative example II for explaining advantages of the present invention; and

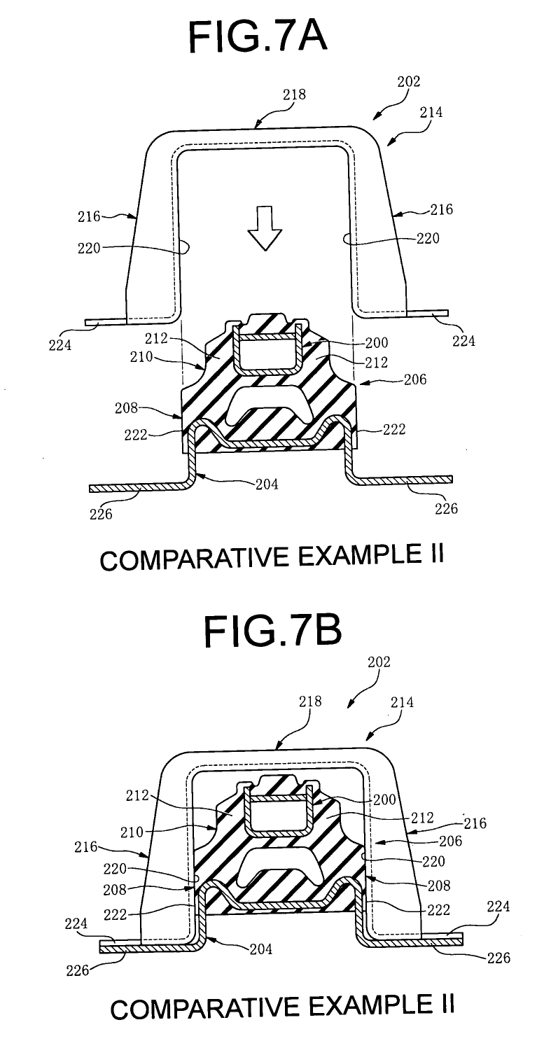

FIG. 8 is a illustration for explaining a problem in the comparative example II.

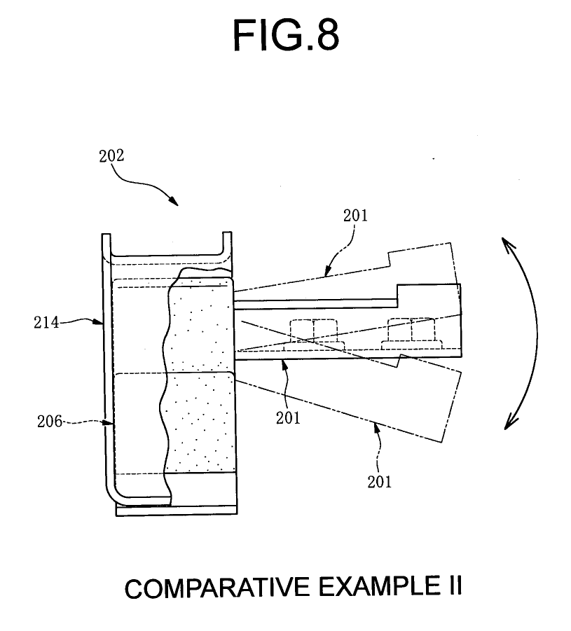

### DETAILED DESCRIPTION OF PREFERRED EMBODIMENTS

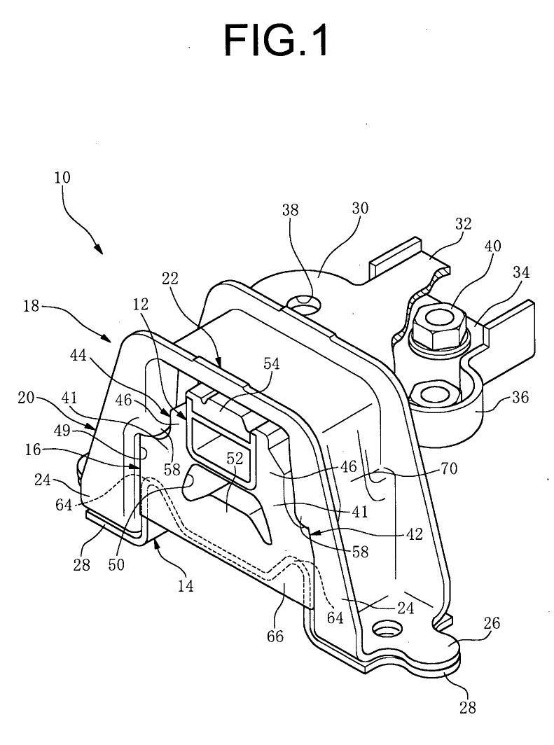

The embodiment of the invention will be described in detail hereinbelow, with reference to the drawings. In FIGS. 1, 3 and 4, 10 denotes an engine mount for a vehicle according to the embodiment, which has an upper metal member (upper rigid member) 12 fastened to an engine side, a lower metal member (lower rigid member) 14 fastened to a vehicle body side, a rubber elastic body 16 connecting these, and a bridge shaped stopper metal member (rigid stopper member) 18 constituted as a separate element from the above. The rubber elastic body 16 is integrally bonded by vulcanization to the upper and lower metal members 12, 14 during vulcanization molding thereof.

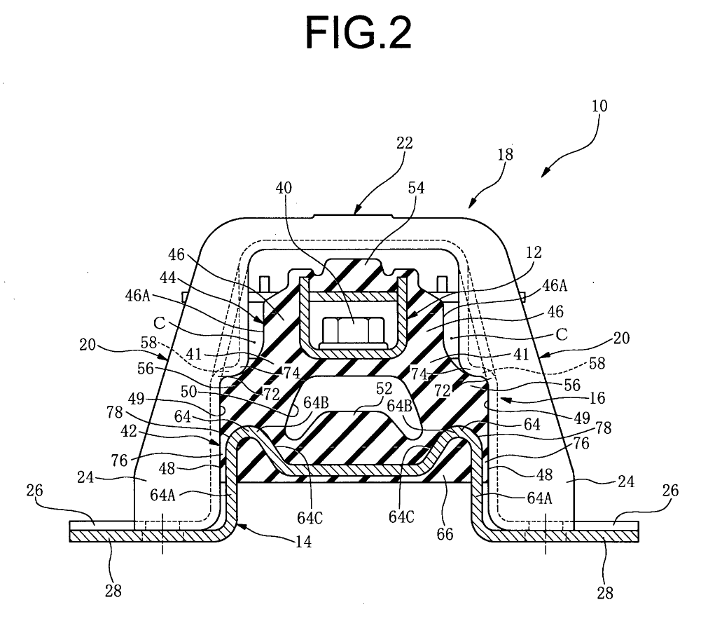

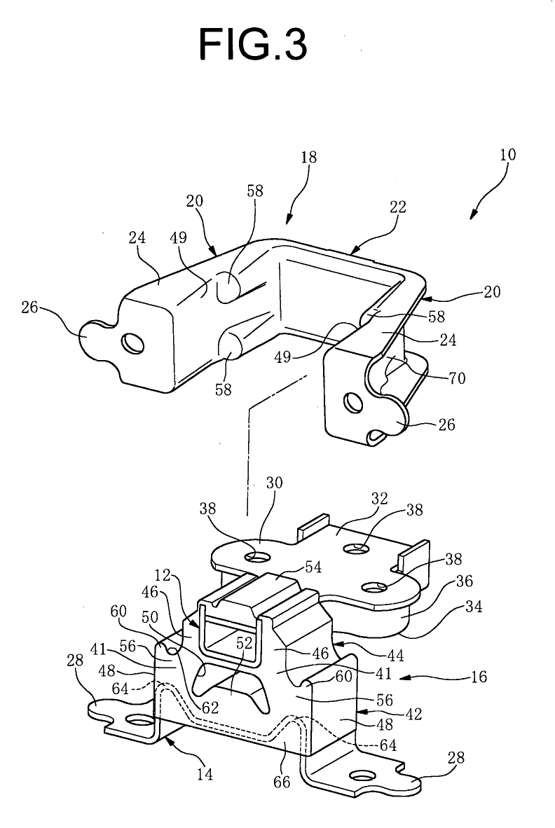

The bridge shaped stopper metal member 18 has a pair of front and back leg portions 20, and a bridge portion 22 linking the pair of leg portions 20 in a front-back direction of the vehicle. As shown in FIGS. 1 and 3, the stopper metal member 18 is provided with reinforcing ribs 24 at both ends in the vehicle left-right direction (perpendicular to the plane of the paper in FIG. 2). A fastener portion 26 is disposed at each bottom end of the pair of leg portions. These fastener portions 26 are designed to be fasten to corresponding fastener portions 28 of the lower metal member 14.

The aforementioned upper metal member 12 is a hollow tube of rectangular cross section in the portion thereof that fastens to the rubber elastic body 16, and is affixed to the rubber elastic body 16 by means of vulcanization bonding while embedded entirely within the rubber elastic body 16.

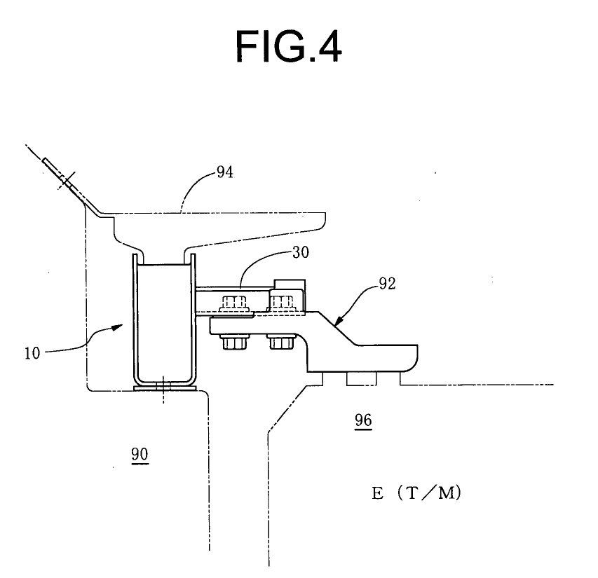

As shown in FIGS. 1, 3 and 4, a bracket 30 for fastening to the engine (specifically the transmission) 96 side is integrally constituted projecting leftward in the drawings from the upper metal member 12, the bracket 30 being supported in cantilever fashion on the rubber elastic body 16. In FIG. 4, symbol 90 denotes the vehicle body, 92 denotes a bracket on the engine 96 side, and 94 denotes a bracket on the vehicle body side, for fastening the engine mount 10 to the vehicle body 90. That is, this engine mount 10 is a left engine mount situated on the left side of the engine 96 and providing vibration damping support to the edge on the left side of the engine 96 (specifically the transmission integrally constituted with the engine 96).

As shown in FIG. 1, the bracket 30 is of flatted tube shape overall having an upper panel 32, a lower panel 34, and a side wall 36. Through-holes 38 are formed at three locations in the upper panel 32, and through-holes 38 concentric therewith are formed in the lower panel 34 as well. On the upper face of the lower panel 34, a nut 40 positioned concentrically with the through-holes 38 are affixed by means of welding (see FIG. 2). This nut 40 is used for fastening to the engine 96 side.

The rubber elastic body 16 has a front/back pair of rubber legs 41 for supporting the load of the engine 96. The front-back dimension of an upper half 44 of the rubber elastic body 16 is smaller than the front-back dimension of a lower half 42 of the rubber elastic body 16, with the front and back portions of the upper half 44 thereof with respect to the upper metal member 12 constituting front-back direction rubber stopper portions 46 situated opposed to leg portions 20 of the bridge shaped stopper metal member 18, and spaced apart therefrom by stopper clearance C. These stopper faces are denoted by 46A in the drawing. These rubber stopper portions 46 come into abutment with inside surfaces 49 of the leg portions 20 of the stopper metal member 18 to produce stopper action when the engine 96 undergoes appreciable displacement in the front-back direction, thereby restricting excessive displacement of the engine 96.

On the other hand the front and back faces of the lower half 42 constitute contact faces 48 with the stopper metal member 18, these contact faces 48 coming into elastic pressing contact with the inside surfaces 49 of the leg portions 20. That is, the rubber elastic body 16 is elastically clamped in the front-back direction in its lower half 42 by the front/back pair of leg portions 20 of the bridge shaped stopper metal member 18.

In the rubber elastic body 16 in the embodiment, with the stopper metal member 18 having been attached, portions extending from the front and back stopper faces 46A of the rubber stopper portions 46 down to the contact faces 48 of the lower half 42 extend in the front and back directions moving downward and are continuous with the contact faces 48, without creating a constricted portion in the front-back direction at midpoint.

A lightening portion (recess) 50 passing through the center portion is formed in this rubber elastic body 16. On the bottom of this lightening portion 50, there is formed a rubber stopper portion 52 that produces a stopper action during bound. On the upper side of the upper metal member 12, there is formed a rubber stopper portion 54 that comes into abutment with the bridge portion 22 of the stopper metal member 18 to produce a stopper action during rebound.

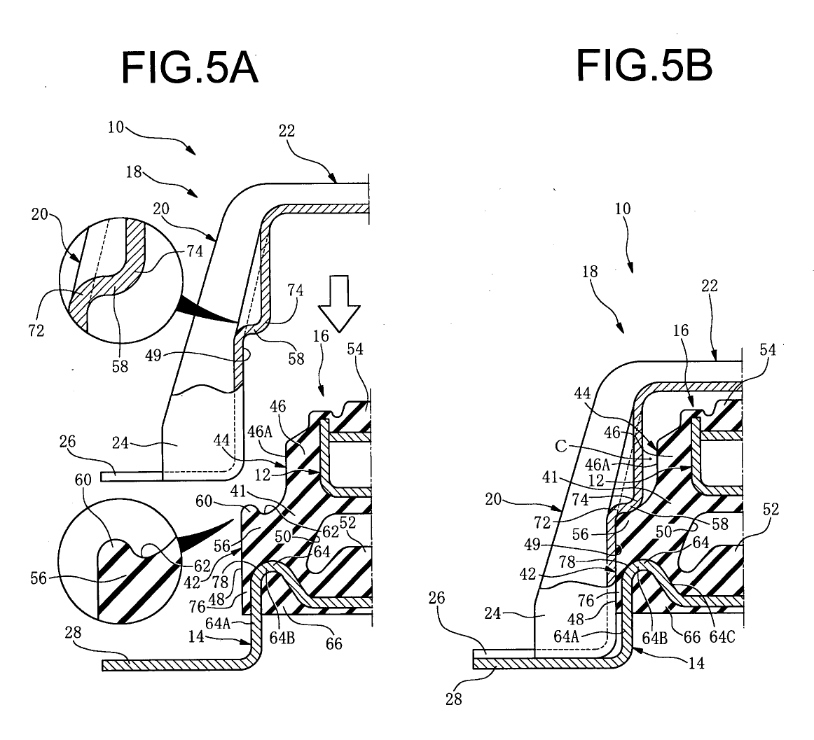

As shown in FIGS. 3, 5A and 5B, a pair of shoulder portions 56 of step configuration projecting in the front-back direction (left-right direction in the drawings) are disposed at front and back at an upper end of the lower half 42 of the rubber elastic body 16. A pair of downturned pressing portions 58 of step configuration are disposed at corresponding front and back locations on the bridge shaped stopper metal member 18. With the stopper metal member 18 attached, the shoulder portions 56 are pressed downwardly by the pressing portions 58 in association with compressive elastic deformation of the lower half 42. By means of this pressing force, the lower half 42, specifically, the front and back ends, are securely fastened with respect to the lower metal member 14 and the bridge shaped stopper metal member 18.

As shown in FIG. 3, the pressing portions 58 are disposed respectively at front and back, and further are disposed at each end of the stopper metal member 18 in its width direction (vehicle left-right direction). The portion between these pressing portions 58 and 58 in the width direction is constituted as a reinforcing rib 70 of sloping shape (see FIG. 1). As shown in FIG. 5A, the aforementioned shoulder portion 56, in the shape thereof prior to attachment of the stopper metal member 18, of a portion that contacts the pressing portion 58, an outer portion thereof in the front-back direction forms an upwardly projecting convex portion 60, and an inner portion continuous therewith forms a concave portion 62 with a relatively downward facing bowed shape. The upwardly projecting convex portion 60 is disposed on the shoulder portion 56 at a most outer peripheral edge portion thereof in the front-back direction.

Accordingly, the upwardly-directed pressing force of the pressing portions 58 is applied primarily to the convex portion 60. The convex portion 60 undergoes elastic deformation due to this pressing force, and in association therewith the rubber of the convex portion 60 is displaced over into the concave portion 62. The convex portion 60 and the concave portion 62 are formed continuously over their entire width with uniform height and depth in the width direction of the rubber elastic body 16. The pressing portion 58 has a shape that, once assembled, presses the convex portion 60 downwardly until it is rendered non-convex. The pressing portion 58 has a bowed portion (rounded portion) 72 that bows in the same direction as the convex portion 60, and a bowed portion (rounded portion) 74 that bows in the opposite direction.

As shown in FIG. 2, the aforementioned lower metal member 14 is disposed with the fastener portion 28 for fastening to the rubber elastic body 16 embedded within the rubber elastic body 16, and with the front end and back end thereof, specifically the portions opposed in the vertical direction to the pressing portions 58 in the stopper metal member 18, constitute upturned convex portions 64. The upturned convex portion 64 has a straight shaped portion 64A that rises straight upwardly along the leg portion 20 in the stopper metal member 18, an inflection portion 64B that bows at the upper edge and inflects downward, and a sloping portion 64C continuous therewith and having a sloping shape.

The inflection portion 64B has an arcuate pressure surface 78 that extends from its vertex towards the inside surface 49 of the corresponding leg portion 20 while extending downwardly. Upon assembling the stopper metal member 18, this pressure surface 78 function to press the rubber elastic body 16 toward the inside surface 49 side of the leg portion 20. In this arrangement, the shoulder portion 56 of the rubber elastic body 16 extends outward of the vertex of the inflection portion 64B in the front-back direction, i.e., extends towards the corresponding leg portion. As will be understood from FIG. 5A, the convex portion 60 of the shoulder portion 56 is disposed outward of the inflection portion 64B, i.e., is positioned more closer to the corresponding leg portion 20 than the inflection portion 64B.

The straight shaped portion 64A has a thin rubber layer 76 constituting part of the rubber elastic body 16 formed between it and the leg portion 20. The aforementioned convex portion 64, particularly the sloping portion 64C thereof, has the function of giving stiffer spring characteristics in the vertical direction of the rubber elastic body 16.

A rubber underlayer 66 is formed in the lower portion thereof. This rubber underlayer 66 constitutes part of the rubber elastic body 16, and is integrally joined with the upper portion of the lower metal member 14. The lower metal member 14 is covered on the left and right end faces thereof perpendicular to the plane of the paper in FIG. 2 by the rubber elastic body 16.

As shown in FIG. 5A, in the engine mount 10 of this embodiment, the bridge shaped stopper metal member 18 is positioned above the rubber elastic body 16, and pushed in downwardly in the drawing to attach the stopper metal member 18 to the rubber elastic body 16 and the lower metal member 14. More specifically, when the stopper metal member 18 is pushed in downwardly, the rubber elastic body 16 becomes press fit into the stopper metal member 18 through an opening in the bottom end, and the fastener portions 26 of the pair of lower ends of the stopper metal member 18 are then fastened to the fastener portions 28 of the lower metal member 14, attaching the bridge shaped stopper metal member 18 to the rubber elastic body 16 and the lower metal member 14.

At this time, the lower half 42 of the rubber elastic body 16 is elastically clamped in the front-back direction by the pair of leg portions 20 of the stopper metal member 18, and the contact faces 48 at front and back of the lower half 42 are disposed in elastic pressing contact against the inside surfaces 49 of the leg portions 20 of the stopper metal member 18.

Further, the pressing portions 58 of the stopper metal member 18 exert downward pressing force against the shoulder portions 56 of the lower half 42, and by means of the pressing force of the pressing portions 58, the front and back ends of the lower half 42 are fastened to the stopper metal member 18, in a state of elastic compressive deformation in the vertical direction.

At this time, the front and back ends of the lower half 42 are clamped in the vertical direction by the pressing portions 58 and the lower metal member 14, affording strong anchoring force.

In the embodiment as described above, the shoulder portions 56 are disposed on the lower half 42 of the rubber elastic body 16, and these are pressed by corresponding pressing portions 58 provided on the bridge shaped stopper metal member 18, securely fastening the lower half 42, whereby in the engine mount 10 that provides vibration-damping support of an engine 96 in a suspension system, in which, due to left/right rocking motion of the engine 96 in pitching mode. Additionally due to the bracket 30 being integrally constituted in a cantilever fashion on the upper metal member 12, the bracket 30 undergoes appreciable rotary motion in the vertical direction, and a high level of force acts so as to produce relative motion in the vehicle left-right direction of the lower half 42 of the rubber elastic body 16 and the stopper metal member 18, it is nevertheless possible to suppress the rubbing of the contact faces 48 of the lower half 42 against the stopper metal member 18, and to thereby better prevent abrasion of the rubber elastic body 16 due to such rubbing, as well as the noise produced by such rubbing.

In this embodiment, the upper metal member 12 and the lower metal member 14 are bonded by vulcanization to the rubber elastic body 16, and the anchoring force of the lower metal member 14 to the lower half 42 of the rubber elastic body 16 is strong. Thus, rubbing of the contact faces 48 of the rubber elastic body 16 and the noise produced by this rubbing can be better prevented.

In this embodiment, since the outer portion in the front-back direction of the shoulder portion 56 constitutes the convex portion 60 and the inner portion constitutes the concave portion 62, even where the shoulder portions 56 of the rubber elastic body 16 are in a state of being pressed downwardly by means of attaching the stopper metal member 18, concentrations of stress in the border regions can be avoided. The problem of cracks occurring from these regions and diminishing durability can be effectively solved.

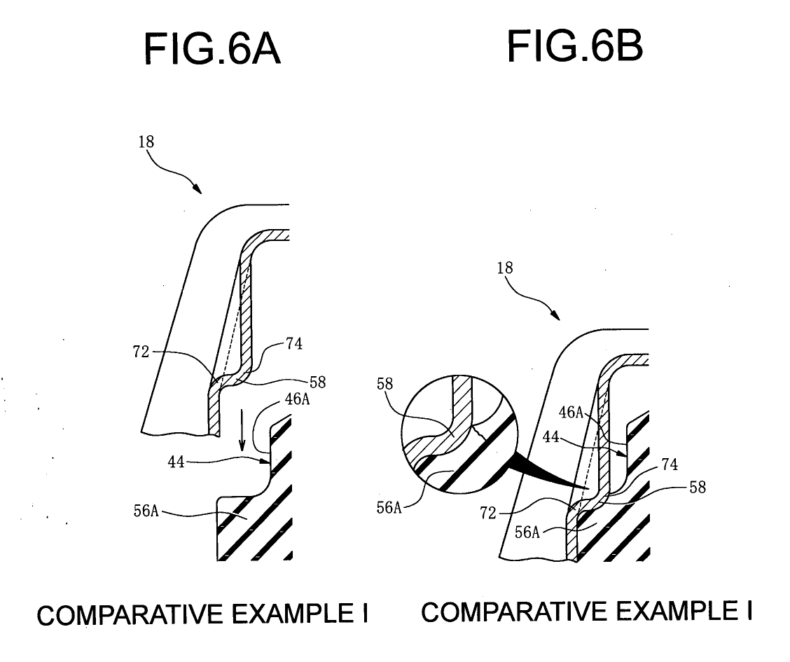

Specifically, as shown in a comparative example I diagram of FIGS. 6A and 6B, where the shape of a shoulder portion 56A is a shape that contacts the pressing portion 58 of the stopper metal member 18 with equal force at all points, relative displacement of the engine 96 during use will be accompanied by concentrations of stress being produced in border regions between the portion contacted by the pressing portions and the portion not contacted, and cracks can occur from these sites, thus creating the problem of diminished durability of the engine mount 10. Nevertheless, with this embodiment, since the shape of the shoulder portion 56 has the shape described hereinabove, concentrations of stress in specific regions can be better avoided, and better durability of the engine mount 10 achieved.

Further, the shoulder portions 56 are formed along its entire width direction (vehicle left-right direction) of the rubber elastic body 16, whereas the pressing portions 58 are disposed partially at each end in the width direction of the stopper metal member 18, with portions lying between the pressing portions 58 at the ends in the width direction being constituted as reinforcing ribs 70. Therefore, diminished strength of the stopper metal member 18 in the front-back direction due to formation of the pressing portions 58 may be prevented, and rigidity and strength of the stopper member in the front-back direction can be maintained at high levels of rigidity and strength.

In this embodiment, the portions of the lower metal member 14 opposed in the vertical direction to the pressing portions 58 in the stopper metal member 18 are constituted as upturned convex portions 64. Therefore, the front end and the back end of the lower half 42 in the rubber elastic body 16 can be fastened more securely by means of the pressing portions 58 of the stopper metal member 18 and the convex portions 64 of the lower metal member 14. Also, rubbing of the stopper metal member 18 of the rubber elastic body 16 against the contact faces 48 can be effectively suppressed. The upturned convex portions 64 of this lower metal member 14 also have the action of producing a stiffer spring constant of the rubber elastic body 16. Thus, there is the additional advantage that by varying the projection height of the convex portions 64, the tuning range of the spring constant of the rubber elastic body 16 is expanded.

According to this embodiment, the pressure surface 78 of arcuate shape (or alternatively inclined shape) is formed in the upturned convex portion 64 of the lower metal member 14, while the shoulder portion 56 of the rubber elastic body 16 is configured so as to extend toward the inside surface 49 of the corresponding leg portion 20 beyond the vertex of the inflection portion 64B. With this arrangement, when the stopper metal member 18 is assembled, and the shoulder portion 56 of the rubber elastic body 16 undergoes compression elastic deformation in downward direction by means of the pressing portions 58, a portion of the rubber elastic body 16 under compression deformation is forcedly pressed by means of the pressure surface 78 toward the inside surface 49 of the leg portion 20. Thus, the rubber elastic body 16 can be forcedly press fitted against the inside surface 49 of the front and back leg portions 20, 20. With this arrangement, the rubber elastic body 16, more specifically the lower half 42 of the rubber elastic body 16 can be restricted with a greatly increased force, and thus fastened to the leg portions 20, 20 with great fastening force.

The portion of the rubber elastic body 16, which is pressed outwardly by means of the pressure surface 78, is held in a compressed state between the inside surface 49 of the leg portion 20 in the front-back direction. Therefore, if the bracket 30 moves in a vertical direction, this motion can be efficiently absorbed by means of this advance compression of the rubber elastic body 16. This advantage, together with the aforementioned increase of the fastening force, makes it possible to further effectively restrict rubbing between the contact face 48 of the rubber elastic body 16 and the inside surface 49 of the corresponding leg portion 20. Thus, further effectively prevented is occurrence of abrasion of the rubber elastic body 16 due to such rubbing, as well as the noise produced by such rubbing.

In addition, the upwardly projecting convex portion 60 is disposed on the shoulder portion 56 at the most outer peripheral edge portion thereof in the front-back direction. Therefore, when the upwardly projecting convex portions 60 are forcedly pressed downwardly by means of the pressing portions 58, the created compression elastic deformational force is promptly converted into the compression force toward the inside surface 49 of the front and back leg portions 20, 20 in the front-back direction. With this arrangement, the frictional force generated between the contact faces 48 and the inside surfaces 49 will be enhanced, thereby generating increased fixing force therebetween. Also, the pre-compression force will also be enhanced, thereby effectively preventing abrasion of the rubber elastic body 16 due to such rubbing, as well as the noise produced by such rubbing.

Since the convex portions 64 of the lower metal member 14 are embedded within an interior of the lower half 42 of the rubber elastic body 16, and exert restraining action from within on the portion of the lower half 42 which is clamped by the stopper metal member 18, rubbing of the lower half 42 in the rubber elastic body 16 and noise resulting from this can be more effectively prevented.

In this case, the convex portion 64 of the lower metal member 14 has the straight shaped portion 64A that rises straight along the leg portion 20 in the bridge shaped stopper metal member 18. Therefore, with the thin rubber layer 76 constituting part of the rubber elastic body 16 being formed between the straight shaped portion 64A and the leg portion 20, the lower half 42 of the rubber elastic body 16 is held between the straight shaped portion 64A and the leg portion 20 at uniform thickness over a predetermined distance in the vertical direction, whereby the desired interference can be readily assured when attaching the rubber elastic body 16 by press metal member into the bridge shaped stopper metal member 18.

Further, an entire fastener portion 28 of the lower metal member 14 to the rubber elastic body 16 is embedded in an interior of the rubber elastic body 16. Therefore, with the rubber underlayer 66 constituting part of the rubber elastic body 16 being formed therebelow, at the time of integral vulcanization bonding of the lower metal member 14 to the rubber elastic body 16 during vulcanization molding, it is not necessary to give the forming mold a cut structure for the lower metal member 14. Thus, the design of the forming mold and the structure of the engine mount 10 may be simplified, as well as solving the problem of rubber flash at the end of the lower metal member 14. Further, the labor entailed in performing a separate anticorrosive coating process on the bottom face of the lower metal member 14 may be avoided.

In the engine mount 10 of the embodiment, by means of appropriate selection of the locations of the shoulder portions 56 and the pressing portions 58, the level of compressive deformation applied to the lower half 42 can be appropriately modified and adjusted. Thus, it is possible to variously adjust the spring constant of the rubber elastic body 16, i.e. of the engine mount 10. Table 1 gives an example of vertical and front-back spring constants in the case where the aforementioned shoulder portions 56 and the pressing portions 58 are provided, and in the case where they are not; as will be apparent from the table, spring constant in the vertical direction is increased appreciably by providing the shoulder portions 56 and the pressing portions 58.

[Table 1]

TABLE 1

| | |
|---|---|
| with shoulder | without shoulder |
| portions, | portions, |
| pressing portions | pressing portions |

| Vertical | front-back | vertical | front-back |
|---|---|---|---|
| 155 | 125 | 145 | 125 |

(unit: N/mm)

By being able to adjust spring constant in this way, spring constant in the rubber elastic body 16 can be increased in the past to the optimal spring constant to enable easy tuning.

The embodiment of the invention set forth in detail hereinabove is merely exemplary, with various modifications being possible without departing from the spirit of the invention.

What is claimed is:

1. An engine mount for a vehicle comprising:
an upper rigid member fixable to an engine side;
a lower rigid member fixable to an vehicle body side;
a rubber elastic body elastically connecting the upper and lower rigid members; and
a rigid stopper member of overall bridge configuration having a pair of leg portions situated at front and back and a bridge portion linking these leg portions in a front-back direction of the vehicle above the rubber elastic body,
wherein the rubber elastic body has a front-back dimension of an upper half thereof smaller than that of a lower half thereof;
the upper half constitutes a front-back direction rubber stopper portion opposed to and spaced apart from the pair of leg portions of the bridge shaped stopper member in the front-back direction by a stopper clearance;
the bridge shaped stopper member is press fitted onto and attached to the rubber elastic body and the lower rigid member by being assembled through an opening of a lower end thereof, with the lower half clamped elastically between the pair of leg portions;
a rigid bracket for linking the upper rigid member to the engine side is integrally formed on the upper rigid member, with the rubber elastic body supporting the bracket in a cantilever fashion so that an engine secured fastened to the bracket being supported in a suspension fashion;
the upper rigid member and the lower rigid member are integrally vulcanization bonded to the rubber elastic body;
a pair of shoulder portions of step configuration projecting in the front-back direction from an upper end of the lower half are disposed at front and back on the rubber elastic body, while downturned pressing portions of step configuration are disposed at corresponding front and back locations on the bridge shaped stopper member; and
with the stopper member being press fitted onto the rubber elastic body and the lower rigid member, the pressing portions of the stopper member press downwardly the shoulder portions of the rubber elastic body causing compression deformation of the lower half, producing a state of fixation of the lower half to the stopper member.

2. An engine mount according to claim 1, wherein each of the shoulder portion has a shape prior to attachment of the stopper member, in which a portion that contacts the pressing portion includes an upwardly projecting convex portion at an outer portion thereof in the front-back direction, and a relatively downward facing concave portion at an inner portion thereof.

3. An engine mount according to claim 2, wherein the pressing portion has a shape that presses the upwardly projecting convex portion until the convex portion is rendered non-convex by means of attachment.

4. An engine mount according to claim 1, wherein each of the shoulder portions is formed over an entirety of a width direction of the rubber elastic body which is a left-right direction of the vehicle, and each of the pressing portions is formed as a pair of pressing portions located at opposite ends in a width direction of the stopper member, with a portion lying between the pair of pressing portions at the opposite ends in the width direction being constituted as a reinforcing rib.

5. An engine mount according to claim 1, wherein in the rubber elastic body, portions extending from front and back stopper faces down to front and back contact faces of the lower half against the stopper member are continuous with contact faces without creating a constricted portion in the front-back direction at midpoint.

6. An engine mount according to claim 1, wherein portions of the lower rigid member that are opposed vertically to the pressing portions are formed as upturned convex portions.

7. An engine mount according to claim 6, wherein each of the upturned convex portions of the lower rigid member includes in an outside of a vertex thereof in the front-back direction, a pressure surface extending towards an inside surface of the leg portion opposed thereto as it goes downward, and the corresponding shoulder portion of the rubber elastic body is configured so as to extend toward the inside surface of the corresponding leg portion beyond the vertex.

8. An engine mount according to claim 7, wherein the shoulder portions of the rubber elastic body have the upturned convex portions at their most outer peripheral edge portions in the front-back direction.

9. An engine mount according to claim 6, wherein the convex portions of the lower rigid member are embedded within an interior of the lower half of the rubber elastic body, and exerts restraining action from an interior of the rubber elastic body against portions of the lower half clamped by the stopper member.

10. An engine mount according to claim 9, wherein the convex portions of the lower rigid member have straight shaped portions that rise straight along the leg portions in the bridge shaped stopper member, with thin rubber layers constituting part of the rubber elastic body being formed between the straight shaped portions and the leg portions, respectively.

11. An engine mount according to claim 1, wherein an entire fastener portion to the rubber elastic body of the lower rigid member is embedded within the rubber elastic body, with a rubber underlayer constituting part of the rubber elastic body being formed below the lower rigid member.
